(19) United States
(12) Patent Application Publication
(10) Pub. No.: US 2025/0032920 A1
(43) Pub. Date: Jan. 30, 2025

(54) EQUIPMENT SUGGESTION METHOD FOR VIRTUAL OBJECT, TERMINAL, AND STORAGE MEDIUM

(71) Applicant: TENCENT TECHNOLOGY (SHENZHEN) COMPANY LIMITED, Shenzhen (CN)

(72) Inventor: Jianfeng LIAN, Shenzhen (CN)

(21) Appl. No.: 18/915,473

(22) Filed: Oct. 15, 2024

Related U.S. Application Data
(63) Continuation of application No. PCT/CN2023/123842, filed on Oct. 10, 2023.

(30) Foreign Application Priority Data
Nov. 17, 2022 (CN) 202211441489.7

(51) Int. Cl. A63F 13/5375

(52) U.S. Cl. CPC A63F 13/5375

(57) ABSTRACT

An equipment suggestion method for a virtual object, performed by a terminal, includes displaying a virtual environment interface corresponding to a first virtual object, a virtual environment comprising a second virtual object; displaying an equipment suggestion region of the second virtual object in response to receiving an equipment suggestion trigger operation on the second virtual object; displaying suggestion information in the equipment suggestion region in response to receiving an equipment suggestion editing operation in the equipment suggestion region, the suggestion information indicating an equipment configuration recommended by a first account to a second account, the first account being a master account of the first virtual object, and the second account being a master account of the second virtual object; and transmitting the suggestion information to the second account through the first account in response to receiving an equipment suggestion confirmation operation in the equipment suggestion region.

### CROSS-REFERENCES TO RELATED APPLICATIONS

The present disclosure is a continuation application of PCT Patent Application No. PCT/CN2023/123842, filed on Oct. 10, 2023, which claims priority to Chinese Patent Application No. 202211441489.7, filed on Nov. 17, 2022, all of which is incorporated herein by reference in their entirety.

### FIELD OF THE TECHNOLOGY

Embodiments of the present disclosure relate to the field of application technologies and, in particular, to an equipment suggestion method and apparatus for a virtual object, an equipment adjustment method and apparatus for a virtual object, a medium, and a product.

### BACKGROUND OF THE DISCLOSURE

In competitive mobile games, virtual objects of different types have their own divisions of work. For example, shooters and mages are responsible for damage output, while supports are responsible for protecting teammates.

The virtual objects in different divisions of work have respective focus abilities, and certain ability of each virtual object may be enhanced through equipment building (equipment purchased in a game), or certain ability of countering an opponent virtual object may be enhanced through equipment building (e.g., outfitting). Therefore, during a game, equipment building of the virtual object has an important impact on a victory or defeat of the game.

For equipment building, game players may often communicate with each other by voice conversation. However, in such a communication manner, it is difficult to accurately express equipment that needs to be purchased and sold, resulting in inefficient human-computer interaction.

### SUMMARY

One embodiment of the present disclosure provides an equipment suggestion method for a virtual object performed by a terminal. The method includes displaying a virtual environment interface corresponding to a first virtual object, a virtual environment comprising a second virtual object; displaying an equipment suggestion region of the second virtual object in response to receiving an equipment suggestion trigger operation on the second virtual object; displaying suggestion information in the equipment suggestion region in response to receiving an equipment suggestion editing operation in the equipment suggestion region, the suggestion information indicating an equipment configuration recommended by a first account to a second account, the first account being a master account of the first virtual object, and the second account being a master account of the second virtual object; and transmitting the suggestion information to the second account through the first account in response to receiving an equipment suggestion confirmation operation in the equipment suggestion region.

Another embodiment of the present disclosure provides a terminal. The terminal includes one or more processors and a memory coupled to the one or more processors and containing program instructions that, when being executed, cause the one or more processors to perform: displaying a virtual environment interface corresponding to a first virtual object, a virtual environment comprising a second virtual object; displaying an equipment suggestion region of the second virtual object in response to receiving an equipment suggestion trigger operation on the second virtual object; displaying suggestion information in the equipment suggestion region in response to receiving an equipment suggestion editing operation in the equipment suggestion region, the suggestion information indicating an equipment configuration recommended by a first account to a second account, the first account being a master account of the first virtual object, and the second account being a master account of the second virtual object; and transmitting the suggestion information to the second account through the first account in response to receiving an equipment suggestion confirmation operation in the equipment suggestion region.

Another embodiment of the present disclosure provides a non-transitory computer-readable storage medium containing program instructions that, when being executed, cause at least one processor to perform: displaying a virtual environment interface corresponding to a first virtual object, a virtual environment comprising a second virtual object; displaying an equipment suggestion region of the second virtual object in response to receiving an equipment suggestion trigger operation on the second virtual object; displaying suggestion information in the equipment suggestion region in response to receiving an equipment suggestion editing operation in the equipment suggestion region, the suggestion information indicating an equipment configuration recommended by a first account to a second account, the first account being a master account of the first virtual object, and the second account being a master account of the second virtual object; and transmitting the suggestion information to the second account through the first account in response to receiving an equipment suggestion confirmation operation in the equipment suggestion region.

### BRIEF DESCRIPTION OF THE DRAWINGS

FIG. 1 is a schematic diagram of an interface of an equipment suggestion for a virtual object according to an exemplary embodiment of the present disclosure.

FIG. 2 is a schematic diagram of an interface of equipment adjustment for a virtual object according to an exemplary embodiment of the present disclosure.

FIG. 3 is a schematic structural diagram of a terminal according to an exemplary embodiment of the present disclosure.

FIG. 4 is a schematic structural diagram of a computer system according to an exemplary embodiment of the present disclosure.

FIG. 5 is a flowchart of an equipment suggestion method for a virtual object according to an exemplary embodiment of the present disclosure.

FIG. 6 is a schematic diagram of an equipment suggestion region according to an exemplary embodiment of the present disclosure.

FIG. 7 is a flowchart of an equipment suggestion method for a virtual object according to another exemplary embodiment of the present disclosure.

FIG. 8 is a schematic diagram of an equipment suggestion region according to another exemplary embodiment of the present disclosure.

FIG. 9 is a schematic diagram of a virtual environment interface according to an exemplary embodiment of the present disclosure.

FIG. 10 is a flowchart of an equipment suggestion method for a virtual object according to another exemplary embodiment of the present disclosure.

FIG. 11 is a flowchart of an equipment adjustment method for a virtual object according to an exemplary embodiment of the present disclosure.

FIG. 12 is a schematic diagram of a virtual environment interface according to another exemplary embodiment of the present disclosure.

FIG. 13 is a schematic diagram of a virtual environment interface according to another exemplary embodiment of the present disclosure.

FIG. 14 is a flowchart of an equipment adjustment method for a virtual object according to another exemplary embodiment of the present disclosure.

FIG. 15 is a flowchart of an equipment suggestion method for a virtual object according to another exemplary embodiment of the present disclosure.

FIG. 16 is a flowchart of an equipment adjustment method for a virtual object according to another exemplary embodiment of the present disclosure.

FIG. 17 is a block diagram of an equipment suggestion apparatus for a virtual object according to an exemplary embodiment of the present disclosure.

FIG. 18 is a block diagram of an equipment adjustment apparatus for a virtual object according to an exemplary embodiment of the present disclosure.

FIG. 19 is a schematic structural diagram of a computer device according to an exemplary embodiment of the present disclosure.

### DESCRIPTION OF EMBODIMENTS

In competitive mobile games, virtual objects of different types have respective divisions of work. For example, virtual objects such as shooters and mages are responsible for damage output, while virtual objects such as supports are responsible for protecting teammates. Therefore, the virtual objects in different divisions of work have respective focus abilities. During a game, an ability of a virtual object can be enhanced through equipment building. For example, for physicians, an ability of a virtual object to heal a teammate can be enhanced through equipment building. An ability of an opponent virtual object can also be confronted or countered through equipment building. For example, when an attack power of the opponent virtual object is high, self-defense can be enhanced through equipment building, so as to resist damage caused by the opponent virtual object. In addition, equipment building of each virtual object in a same team can affect an overall battle ability of the team. Some players are not proficient in equipment building, and guidance of players proficient in equipment building is required. The present disclosure provides an equipment suggestion method for a virtual object. For a detailed implementation of the method, reference may be made to the following embodiments.

A virtual environment is a scene displayed (or provided) when a client of an application (such as a game application) runs on a terminal. The virtual environment refers to a scene created for a virtual object to perform activities (such as game competition), for example, a virtual house, a virtual island, or a virtual map. The virtual environment may be a simulated scene of a real world, a semi-simulated and semi-fictional scene, or a purely fictional scene. The virtual environment may be a two-dimensional virtual environment, a 2.5-dimensional virtual environment, or a three-dimensional virtual environment.

A virtual object refers to a virtual character controlled by a user account in an application, and the virtual object is movable in the virtual environment. For example, the application is a game application. The virtual object refers to a game character controlled by the user account in the game application. The virtual object may be in a human form, an animal form, a cartoon form, or any suitable form without limitation. The virtual object may be displayed in a three-dimensional form or a two-dimensional form, which is not limited according to various embodiments of the present disclosure.

In different game applications, operations that can be performed by the virtual object controlled by the user account may also be different. For example, in a shooting game application, the user account may control a virtual object to perform operations such as shooting, running, jumping, picking up an item, and changing an item. In another example, in a multiplayer online battle arena (MOBA) game application, the user account may control a virtual object to perform operations such as running, jumping, returning to the city, flashback, and casting ability skill. Certainly, in addition to the game applications, the virtual object may also be presented to a user and provided with a corresponding function in applications of other types, for example, an augmented reality (AR) application, a social application, or an interactive entertainment application.

Virtual equipment refers to equipment worn by a virtual object, such as virtual clothing or a virtual item. For example, the virtual clothing includes virtual boots, a virtual armor, a virtual helmet, a virtual bracelet, a virtual waistband, and the like. The virtual item includes a virtual potion, a virtual bow and arrow, a virtual medical box, a virtual wand, and the like. The virtual equipment may have a functional attribute. For example, the virtual armor worn by the virtual object may reduce a damage value from an enemy. In another example, the virtual wand equipped on the virtual object may cast a spell skill to attack an opponent virtual object. In another example, the virtual medical box of the virtual object may provide a treatment service for a virtual object of a same team.

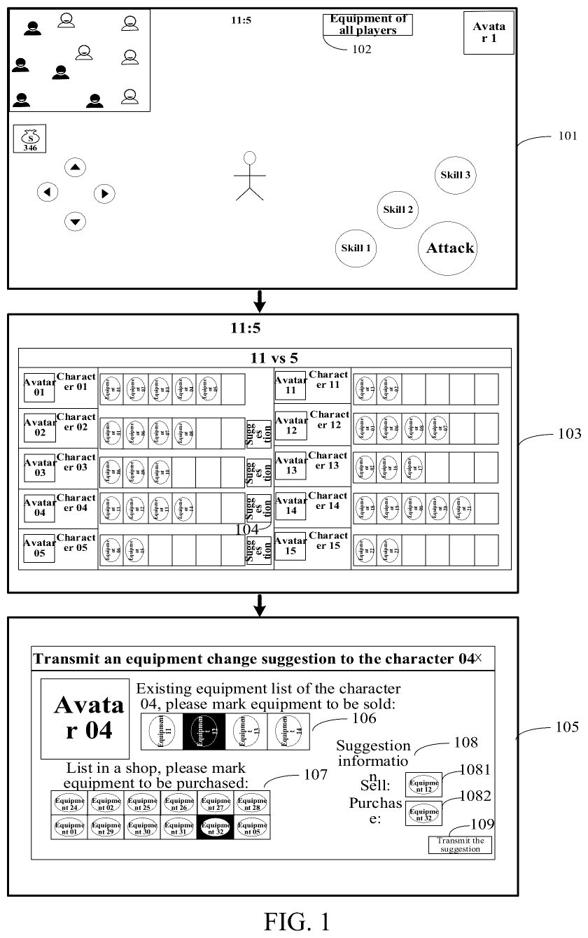

For example, as shown in FIG. 1, an application is run on a first terminal. A virtual environment interface 101 of a “character 01” is displayed in the application. The virtual environment interface 101 includes a virtual environment picture. The virtual environment picture is a picture obtained by observing a virtual environment from a first-person perspective or a third-person perspective of the “character 01”. There are a “character 02”, a “character 03”, a “character 04”, and a “character 05” in the virtual environment. The “character 02”, the “character 03”, the “character 04”, and the “character 05” belong to a same team as the “character 01”. The virtual environment interface 101 includes an equipment viewing control 102. A user performs an equipment viewing operation on the equipment viewing control 102, for example, tapping/clicking the equipment viewing control 102. In response to the equipment viewing operation, the first terminal displays an equipment display region 103 in the application. In the equipment display region 103, a virtual equipment set equipped on each virtual object of our party is displayed, and a virtual equipment set equipped on each opponent virtual object is also displayed. The equipment display region 103 includes a trigger control of an equipment suggestion of each virtual object in the same team (that is, a control marked with a typeface of “suggestion”).

The user performs a trigger operation on an equipment suggestion of the “character 04” on a trigger control 104 corresponding to the “character 04”. An equipment suggestion region 105 of the “character 04” is displayed. A first virtual equipment set 106 equipped on the “character 04” and a candidate second virtual equipment set 107 are displayed on the equipment suggestion region 105. The user performs a selection operation on “equipment 12” in the first virtual equipment set 106. In response to the selection operation on the “equipment 12”, the first terminal generates first suggestion information 1081 of selling the “equipment 12”, and displays the first suggestion information 1081 of selling the “equipment 12” in the equipment suggestion region 105. The user performs a selection operation on “equipment 32” in the second virtual equipment set 107. In response to the selection operation on the “equipment 32”, the first terminal generates second suggestion information 1082 of purchasing the “equipment 32”, and displays the second suggestion information 1082 of purchasing the “equipment 32” in the equipment suggestion region 105.

A confirmation control 109 of an equipment suggestion is further displayed in the equipment suggestion region 105. The user performs a confirmation operation on the confirmation control 109, for example, tapping/clicking the confirmation control 109. In response to the confirmation operation on the equipment suggestion on the confirmation control 109, the first terminal transmits the suggestion information 108 (including the first suggestion information 1081 and the second suggestion information 1082) to a second account through a first account. The first account is a master account of a first virtual object. In FIG. 1, the first account refers to a user account logged in to the application and configured for controlling the “character 01”. The second account is a master account of a second virtual object. In FIG. 1, the second account refers to a user account logged in to the application and configured for controlling the “character 04”.

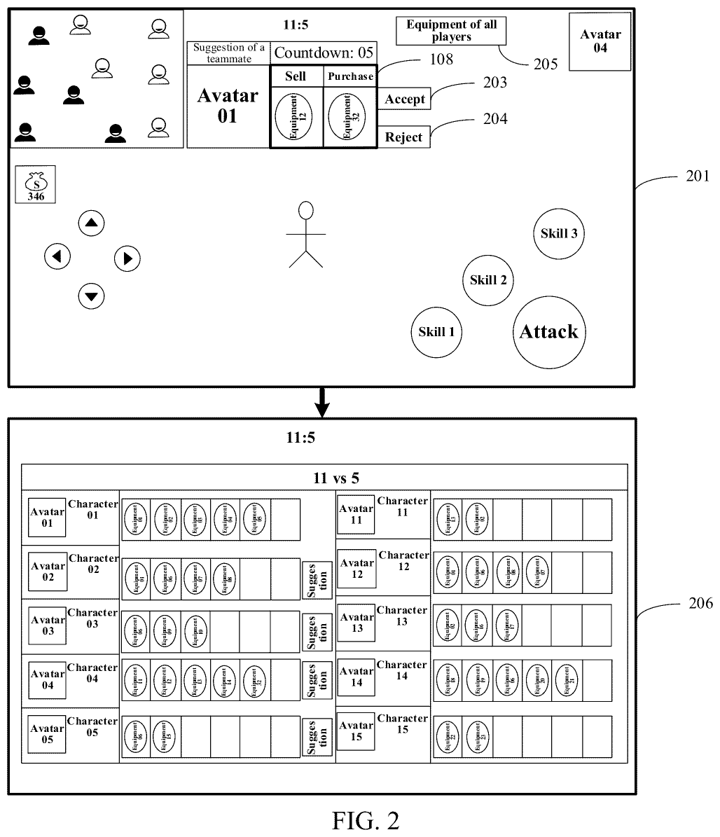

For example, as shown in FIG. 2, an application is run on a second terminal, and a virtual environment interface 201 of a “character 04” is displayed in the application. The virtual environment interface 201 includes a virtual environment picture. The virtual environment picture is a picture obtained by observing a virtual environment from a perspective of the “character 04”. There are a “character 01”, a “character 02”, a “character 03”, and a “character 05” in the virtual environment. The “character 01”, the “character 02”, the “character 03”, and the “character 05” belong to a same team as the “character 04”.

After receiving the suggestion information 108 transmitted to the second account through the first account, the second terminal displays the suggestion information 108 on the virtual environment interface 201, and further displays an acceptance control 203 and a rejection control 204 of the suggestion information 108 on the virtual environment interface 201. The user performs an acceptance operation on the suggestion information on the acceptance control 203, for example, performing a tapping/clicking operation on the acceptance control 203, or adjusting equipment of the “character 04” according to the suggestion information.

As shown in FIG. 2, an equipment viewing control 205 is further displayed on the virtual environment interface 201. The user performs an equipment viewing operation on the equipment viewing control 205, for example, tapping/clicking the equipment viewing control 205. In response to the equipment viewing operation, the second terminal displays an equipment display region 206 in the application, displays a virtual equipment set equipped on each virtual object of our party in the equipment display region 206, and further displays a virtual equipment set equipped on each opponent virtual object in the equipment display region 206. In a virtual equipment set corresponding to the “character 04”, “equipment 12” is unequipped and sold, and “equipment 32” is purchased and equipped.

Based on the foregoing, in the foregoing exemplary embodiments of the present disclosure, a first user holding the first terminal may edit suggestion information in the equipment suggestion region, and then transmit the suggestion information to a second terminal. A second user holding a second terminal may accept an equipment suggestion of the first user, and automatically adjust the equipment of the “character 04” according to the suggestion information. The second user no longer needs to find, according to a suggestion expressed by the first user through a speech, equipment that needs to be adjusted to equip the “character 04”.

The terminal in the present disclosure may be a desktop computer, a laptop computer, a mobile phone, a tablet computer, an ebook reader, a Moving Picture Experts Group Audio Layer III (MP3) player, a Moving Picture Experts Group Audio Layer IV (MP4) player, a laptop portable computer, or the like. An application supporting a virtual scene, for example, an application supporting a three-dimensional virtual scene, is installed and run in the terminal. The application may be any one of a virtual reality application, a three-dimensional map program, a third-person shooting game (TPS), a first-person shooting game (FPS), or a MOBA game.

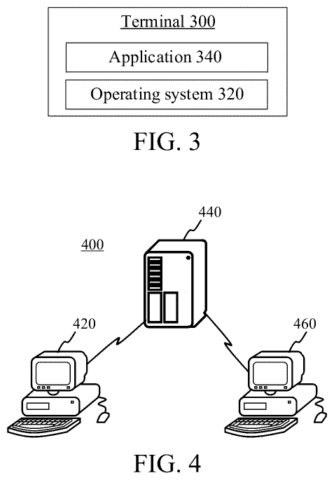

For example, FIG. 3 is a structural block diagram of a terminal according to an exemplary embodiment of the present disclosure. A terminal 300 includes an operating system 320 and an application 340. The application 340 is an application supporting a virtual scene. In some embodiments, the application 340 is an application supporting a three-dimensional virtual scene. FIG. 4 is a block diagram of a computer system according to an exemplary embodiment of the present disclosure. A computer system 400 includes a first terminal 420, a server 440, and a second terminal 460.

An application supporting the virtual scene is installed and run on the first terminal 420. The first terminal 420 is a device used by a first user. The first user uses the first terminal 420 to control a first virtual object in the virtual scene to perform activities, where the activities include but are not limited to at least one of adjusting a body posture, crawling, walking, running, riding, jumping, driving, picking, shooting, attacking, throwing, or casting an ability. For example, the first virtual object is a first virtual character, such as a simulated character role or a cartoon character role. The first terminal 420 is connected to the server 440 by using a wireless network or wired network.

The server 440 includes at least one of one server, a plurality of servers, a cloud computing platform, or a virtualization center. The server 440 is configured to provide a background service for an application that supports a three-dimensional virtual scene. In some embodiments, the server 440 takes on primary computing work, and the first terminal 420 and the second terminal 460 take on secondary computing work; or the server 440 takes on secondary computing work, and the first terminal 420 and the second terminal 460 take on primary computing work; or collaborative computing is performed by using a distributed computing architecture between the server 440, the first terminal 420, and the second terminal 460.

An application supporting the virtual scene is installed and run on the second terminal 460. The second terminal 460 is a device used by a second user. The second user uses the second terminal 460 to control a second virtual object in the virtual scene to perform activities, where the activities include but are not limited to at least one of adjusting a body posture, crawling, walking, running, riding, jumping, driving, picking, shooting, attacking, throwing, or casting an ability. For example, the second virtual object is a second virtual character, such as a simulated character role or a cartoon character role. In some embodiments, the first virtual object and the second virtual object are in the same virtual scene. In some embodiments, the first virtual object and the second virtual object may belong to a same team or a same organization, have a friend relationship, or have a temporary communication permission. In some embodiments, applications installed on the first terminal 420 and the second terminal 460 may be the same, or applications installed on the two devices are applications of a same type on different operating system platforms.

The server 440 may be implemented as a physical server or a cloud server in the cloud. A cloud technology refers to a hosting technology that unifies a series of resources such as hardware, software, and a network in a wide area network or a local area network to realize data calculation, storage, processing, and sharing. The cloud technology is a collective name of a network technology, an information technology, an integration technology, a management platform technology, an application technology, and the like based on an application of a cloud computing business mode, and may form a resource pool, which is used on demand, and is flexible and convenient. A cloud computing technology becomes an important support.

In some embodiments, the server 440 may also be implemented as a node in a block chain system.

In some embodiments, the method according to the embodiments of the present disclosure may be applied to a cloud gaming scene, so that data logic calculation during a game is completed through the cloud server, and a terminal is responsible for displaying a game interface.

Information (including but not limited to user equipment information, user personal information, and the like), data (including but not limited to data for analysis, stored data, displayed data, and the like), and signal involved in the present disclosure are all authorized by users or fully authorized by all parties, and collection, use, and processing of relevant data need to comply with relevant laws, regulations, and standards of relevant countries and regions. For example, game data involved in the present disclosure is obtained under full authorization.

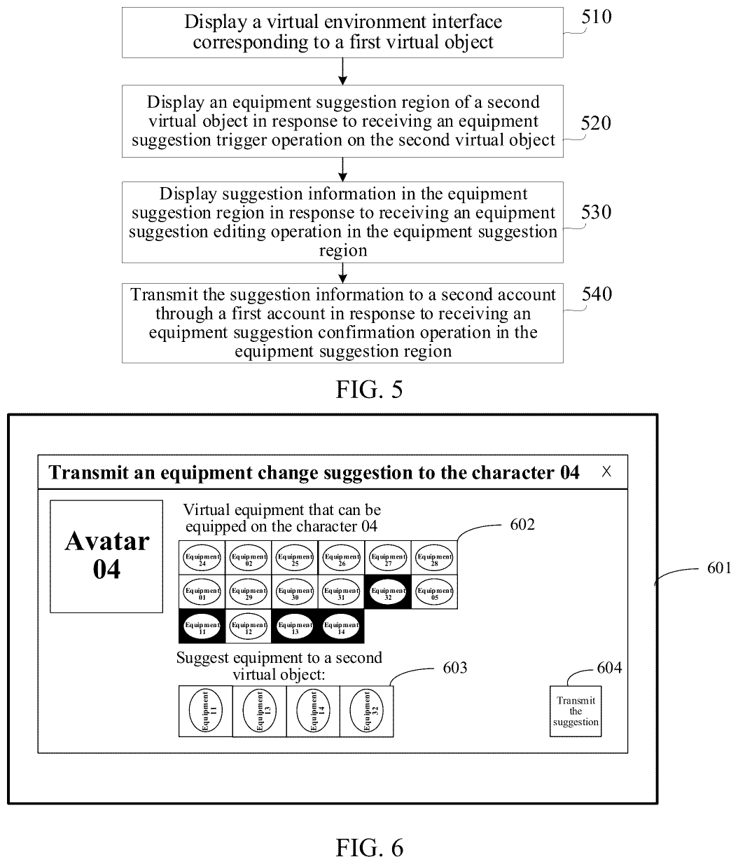

FIG. 5 is a flowchart of an equipment suggestion method for a virtual object according to an exemplary embodiment of the present disclosure. An example in which the method performed by a first terminal is used for description. The method includes the following operations.

Operation 510: Display a virtual environment interface corresponding to a first virtual object.

The first terminal runs an application, and displays the virtual environment interface of the first virtual object in the application. The virtual environment interface includes a virtual environment picture. The virtual environment picture is a picture obtained by observing a virtual environment from a perspective of the first virtual object. The first virtual object and a second virtual object are in the virtual environment. In some embodiments, the second virtual object and the first virtual object belong to a same team. For example, the virtual environment picture is a picture obtained by observing the virtual environment in a battle process.

For example, when the virtual environment is observed from a first-person perspective of the first virtual object, the virtual environment picture does not include the first virtual object; and when the virtual environment is observed from a third-person perspective of the first virtual object, the virtual environment picture includes the first virtual object.

For example, when the second virtual object is located within an observing range of the first virtual object, the virtual environment picture includes the second virtual object, and the second virtual object is displayed on the virtual environment interface; and when the second virtual object is located outside the observing range of the first virtual object, the virtual environment picture does not include the second virtual object, and the second virtual object is not displayed on the virtual environment interface, but the second virtual object is in the virtual environment.

Operation 520: Display an equipment suggestion region of the second virtual object in response to receiving an equipment suggestion trigger operation on the second virtual object.

For example, in response to a trigger operation on an equipment suggestion on the virtual environment interface, the first terminal displays the equipment suggestion region of the second virtual object. For example, in response to a first specified operation on the virtual environment interface, the first terminal displays the equipment suggestion region of the second virtual object in the application. The first specified operation is an operation for triggering the equipment suggestion. For example, the first specified operation may be a knuckle double-tap operation on the virtual environment interface; a specified gesture operation on the virtual environment interface; or a long-press operation on the virtual environment interface.

In some embodiments, in response to an equipment viewing operation on the virtual environment picture, the first terminal displays an equipment display region, where the equipment display region includes first virtual equipment equipped on the second virtual object. After viewing the first virtual equipment equipped on the second virtual object, a first user provides an equipment suggestion for the second virtual object, and performs a trigger operation on the equipment suggestion in the equipment display region. In response to the trigger operation on the equipment suggestion in the equipment display region, the first terminal displays the equipment suggestion region of the second virtual object. For example, in response to a second specified operation on the equipment suggestion region, the first terminal displays the equipment suggestion region of the second virtual object in the application. The second specified operation is an operation for triggering the equipment suggestion. For example, the second specified operation may be a knuckle double-tap operation on the equipment display region; a specified gesture operation on the equipment display region; a long-press operation on the equipment display region; or a trigger control including the equipment suggestion corresponding to the second virtual object in the equipment display region. In response to a trigger operation on the trigger control of the equipment suggestion, the first terminal displays the equipment suggestion region of the second virtual object. As shown in FIG. 1, the equipment viewing control 102 is displayed on the virtual environment interface 101 of the “character 01”. In response to an equipment viewing operation on the equipment viewing control 102, the first terminal displays the equipment display region 103, and in response to a trigger operation on the trigger control 104 of the equipment suggestion corresponding to the “character 04”, the first terminal displays the equipment suggestion region 105 of the “character 04”. A candidate second virtual equipment set of the second virtual object is further displayed in the equipment suggestion region.

Operation 530: Display suggestion information in the equipment suggestion region in response to receiving an equipment suggestion editing operation in the equipment suggestion region.

In some embodiments, the equipment suggestion region includes a first virtual equipment set equipped on the second virtual object and the candidate second virtual equipment set. In response to an editing operation on at least one equipment in the first virtual equipment set and the second virtual equipment set, the suggestion information is generated according to the at least one equipment, and the suggestion information is displayed in the equipment suggestion region. Equipment in the second virtual equipment set refers to virtual equipment that can be equipped on the second virtual object but is still not equipped in a process of making an equipment suggestion.

In some embodiments, a process of selecting at least one equipment to generate the suggestion information includes, but is not limited to, at least one of the following manners:

(1) A virtual equipment set of the second virtual object is displayed in the equipment suggestion region, where the virtual equipment set includes a first virtual equipment set and a second virtual equipment set; and in response to a selection operation on at least one virtual equipment in the virtual equipment set, the suggestion information is generated according to the suggested at least one virtual equipment, and the suggestion information is displayed in the equipment suggestion region. For example, as shown in FIG. 6, a virtual equipment set 602 of a “character 04” is displayed in an equipment suggestion region 601. In response to selection operations on “equipment 11”, “equipment 13”, “equipment 14”, and “equipment 32”, the first terminal displays suggestion information 603 in the equipment suggestion region 601.

(2) In response to a selection operation on first virtual equipment in the first virtual equipment set, first suggestion information is generated according to the first virtual equipment, and the first suggestion information is displayed in the equipment suggestion region, where the first suggestion information is configured for suggesting unequipping the first virtual equipment equipped on the second virtual object. As shown in FIG. 1, the “equipment 12” is selected from the first virtual equipment set 106, and the first suggestion information 1081 of “sell: equipment 12” is generated.

Alternatively, in response to a selection operation on second virtual equipment in the second virtual equipment set, second suggestion information is generated according to the second virtual equipment, and the second suggestion information is displayed in the equipment suggestion region, where the second suggestion information is configured for suggesting equipping the second virtual equipment on the second virtual object. As shown in FIG. 1, the “equipment 32” is selected from the second virtual equipment set 107, and the second suggestion information 1082 of “purchase: equipment 32” is generated.

Alternatively, in response to a selection operation on first virtual equipment in the first virtual equipment set, first suggestion information is generated according to the first virtual equipment, and the first suggestion information is displayed in the equipment suggestion region, where the first suggestion information is configured for suggesting unequipping the first virtual equipment equipped on the second virtual object; and in response to a selection operation on second virtual equipment in the second virtual equipment set, second suggestion information is generated according to the second virtual equipment, and the second suggestion information is displayed in the equipment suggestion region, where the second suggestion information is configured for suggesting equipping the second virtual equipment on the second virtual object.

For example, the suggestion information may be generated by using a template. Specifically, an identifier of selected virtual equipment is filled into the template, and suggestion information is obtained. For example, in response to the selection operation on the at least one equipment in the virtual equipment set, the first terminal fills an identifier of the at least one equipment into a template of the suggestion information, and the suggestion information is displayed in the equipment suggestion region. As shown in FIG. 6, selected identifiers of the “equipment 11”, the “equipment 13”, the “equipment 14”, and the “equipment 32” are directly filled in corresponding positions of templates.

In another example, in response to the selection operation on the first virtual equipment, the first terminal fills an identifier of the first virtual equipment into a template of the first suggestion information, and the first suggestion information is displayed in the equipment suggestion region; and in response to the selection operation of the second virtual equipment, the first terminal fills an identifier of the second virtual equipment into a template of the second suggestion information, and the second suggestion information is displayed in the equipment suggestion region. As shown in FIG. 1, identifiers of the “equipment 12” and the “equipment 32” are directly filled in corresponding positions of templates.

In this embodiment of the present disclosure, a generation order of the first suggestion information and the second suggestion information is consistent with a selection order of the first virtual equipment and the second virtual equipment. There may be one or more selected first virtual equipment, and there may be one or more selected second virtual equipment. On the first terminal, a selection operation may be further performed on the selected virtual equipment again, to cancel the selection of the virtual equipment. Each time virtual equipment is selected or selection of the virtual equipment is canceled, the suggestion information is updated.

Operation 540: Transmit the suggestion information to a second account through a first account in response to receiving an equipment suggestion confirmation operation in the equipment suggestion region.

The first account is an account configured for controlling the first virtual object, and the second account is an account configured for controlling the second virtual object.

For example, as shown in FIG. 1, the equipment suggestion region includes the confirmation control 109 of the equipment suggestion; and in response to a confirmation operation on the equipment suggestion on the confirmation control 109, the suggestion information is transmitted to the second account through the first account. As also shown in FIG. 6, the equipment suggestion region includes a confirmation control 604 of the equipment suggestion; and in response to a confirmation operation on the equipment suggestion on the confirmation control 604, the suggestion information is transmitted to the second account through the first account.

Based on the foregoing, according to the equipment suggestion method for a virtual object provided in this embodiment, a first user controls the first virtual object through the first account. For the second virtual object, the first user may trigger to enter the equipment suggestion region of the second virtual object, edit the suggestion information for equipment of the second virtual object in the equipment suggestion region, and then transmit, through the first account, the suggestion information to the second account controlling the second virtual object, to provide a suggestion for equipment building of the second virtual object. Therefore, a second user may adjust the equipment building of the second virtual object according to the suggestion information, to achieve effective communication about equipment building between virtual objects in the same team.

According to the method provided in this embodiment, the suggestion information is generated through the editing operations on the equipped first virtual equipment set and the unequipped second virtual equipment set, thereby improving generation efficiency of an unequipping suggestion for the equipped equipment and a purchasing suggestion for the unequipped equipment.

In some embodiments, the first user may implement the equipment suggestion for the second virtual object through the selection operation on the virtual equipment, without editing a large amount of text content. An operation of the equipment suggestion is simple. For example, virtual equipment suggested to be unequipped is selected, and virtual equipment suggested to be equipped is selected, so that suggestion information can be generated, and then transmission of the suggestion information is confirmed, to complete the equipment suggestion for the second virtual object.

In some embodiments, the suggestion information is generated by using a template, so that the suggestion information can be generated and displayed faster. For example, an identifier of selected virtual equipment can be quickly displayed in the suggestion information, thereby improving efficiency of human-computer interaction.

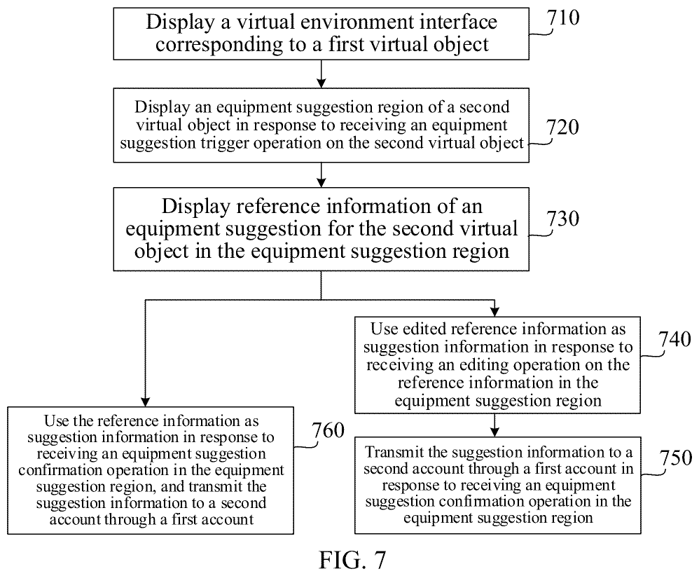

FIG. 7 is a flowchart of an equipment suggestion method for a virtual object according to another exemplary embodiment of the present disclosure. An example in which the method is applied to a first terminal is used for description. The method includes the following operations.

Operation 710: Display a virtual environment interface corresponding to a first virtual object.

Operation 720: Display an equipment suggestion region of a second virtual object in response to receiving an equipment suggestion trigger operation on the second virtual object.

For implementation details of operation 710 and operation 720, reference may be made to operation 510 and operation 520. Details are not described herein again.

Operation 730: Display reference information of an equipment suggestion for the second virtual object in the equipment suggestion region.

The reference information is determined according to equipment information of the second virtual object and equipment information of another virtual object. The another virtual object includes at least one of the following: a virtual object in a same team as the second virtual object (namely, a virtual object of our party in addition to the second virtual object), or a virtual object in an opponent team of the second virtual object (that is, an opponent virtual object).

For example, for displaying of the reference information, the equipment information of the second virtual object and the equipment information of another virtual object are first obtained, where the equipment information includes information about virtual equipment equipped on a virtual object; a virtual equipment set of the second virtual object is obtained, where the virtual equipment set includes a first virtual equipment set and a second virtual equipment set; and suggested equipment information of the second virtual object is determined according to a cooperation relationship with equipment of the virtual object of our party, and/or a confrontation relationship with equipment of the opponent virtual object.

Alternatively, for displaying of the reference information, capability information of the second virtual object and capability information of another virtual object are first obtained, where the capability information includes capability information of virtual equipment equipped on a virtual object, and capability information of the virtual object; the capability information of the second virtual object and capability information of virtual equipment in a virtual equipment set are obtained, where the virtual equipment set includes a first virtual equipment set and a second virtual equipment set; and suggested equipment information of the second virtual object is determined according to a capability cooperation relationship with equipment of the virtual object of our party, and/or a capability confrontation relationship with equipment of the opponent virtual object.

After the suggested equipment information of the second virtual object is obtained, the reference information is generated according to the equipment information; or virtual equipment that needs to be adjusted (for example, virtual equipment that needs to be unequipped, and/or virtual equipment that needs to be equipped) is determined according to the equipment information and the first virtual equipment set, and the reference information is generated according to the virtual equipment that needs to be adjusted.

After being generated by the first terminal, the reference information may be displayed in the equipment suggestion region. Alternatively, after triggering display of the equipment suggestion region, the first terminal transmits an obtaining request of the reference information to a server. The server generates the reference information according to the obtaining request, and then transmits the reference information to the first terminal. After receiving the reference information, the first terminal displays the reference information in the equipment suggestion region.

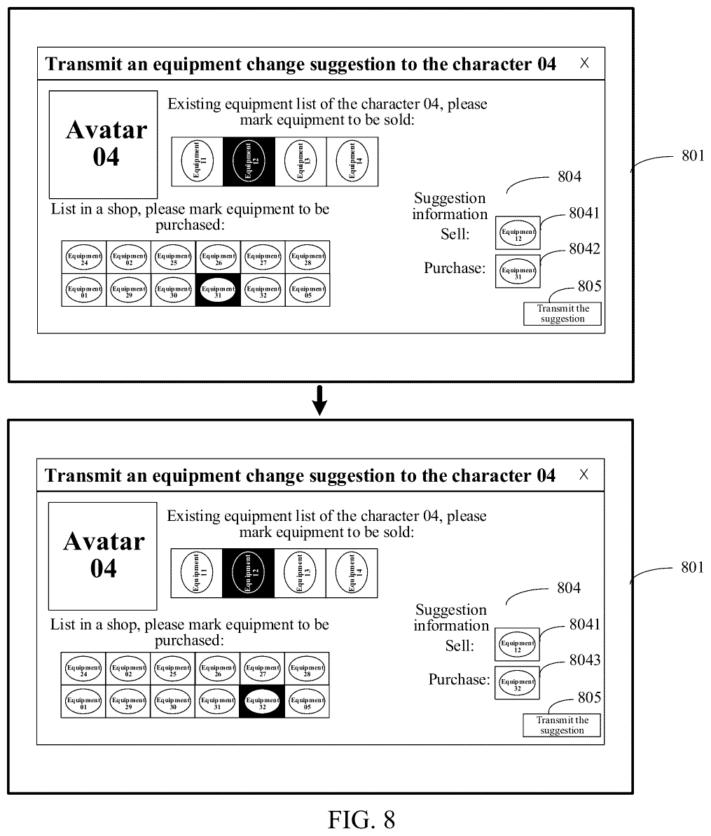

For example, as shown in FIG. 8, reference information 804 is displayed in an equipment suggestion region 801, and the reference information 804 includes first reference information 8041 and second reference information 8042.

Operation 740: Use edited reference information as suggestion information in response to receiving an editing operation on the reference information in the equipment suggestion region.

In some embodiments, the reference information includes suggested third virtual equipment. In response to a selection operation on the third virtual equipment in the reference information, a suggestion for the third virtual equipment in the reference information is canceled (including a suggestion for unequipping the third virtual equipment or a suggestion for equipping the third virtual equipment); and/or in response to a selection operation on fourth virtual equipment, a suggestion for the fourth virtual equipment is generated (including a suggestion for unequipping the fourth virtual equipment or a suggestion for equipping the fourth virtual equipment). After the reference information is adjusted, the suggestion information of the second virtual object is obtained.

For example, as shown in FIG. 8, in response to a selection operation on “equipment 31”, the first terminal cancels selection of the “equipment 31” in the equipment suggestion region, and cancels display of the second suggestion information 8042 of the “equipment 31”; and in response to a selection operation on “equipment 32”, the first terminal generates second suggestion information 8043 of the “equipment 32”.

Operation 750: Transmit the suggestion information to a second account through a first account in response to receiving an equipment suggestion confirmation operation in the equipment suggestion region.

For example, as shown in FIG. 8, in response to a confirmation operation on a confirmation control 805 of an equipment suggestion, the suggestion information is transmitted to the second account through the first account.

Operation 760: Use the reference information as the suggestion information and transmit the suggestion information to a second account through a first account in response to receiving an equipment suggestion confirmation operation in the equipment suggestion region.

Based on the foregoing, according to the equipment suggestion method for a virtual object provided in this embodiment, in the equipment suggestion process of the second virtual object, the first terminal or the server first provides the reference information to a first user for reference. When the reference information does not meet an expectation of the first user, the reference information may be adjusted to obtain suggestion information, so that a valuable reference can be provided for the first user. If some reference suggestions meet the expectation of the first user, the user may perform less suggestion operations and only needs to perform modification based on the reference suggestion. When the reference information meets the expectation of the first user, the reference information may be directly used as final suggestion information, and is transmitted to the second account, without performing the suggestion operation, thereby improving efficiency of human-computer interaction as a whole.

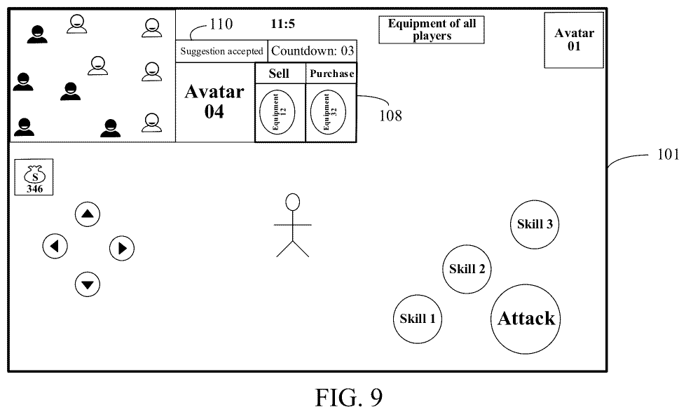

In some embodiments, in response to receiving the equipment suggestion confirmation operation in the equipment suggestion region, the suggestion information is displayed on the virtual environment picture. For example, as shown in FIG. 9, suggestion information 108 is displayed on a virtual environment interface 101.

Subsequently, the first terminal further receives feedback information transmitted by the second account to the first account; and displays the feedback information on the virtual environment picture. The feedback information includes any one of suggestion accepted, suggestion rejected, or suggestion unaccepted after timeout. For example, as shown in FIG. 9, feedback information 110 of “suggestion accepted” is displayed on the virtual environment interface 101. In response to a display duration of the feedback information exceeding a duration threshold, the first terminal cancels display of the feedback information.

For example, a countdown is further displayed on the virtual environment interface 101. Before the feedback information is received, the countdown of the virtual environment interface 101 is configured for counting down a duration of the feedback information transmitted by the second account; and after the feedback information is received, the countdown of the virtual environment interface 101 is configured for counting down a display duration of the feedback information.

The suggestion unaccepted after timeout is implemented as rejecting a suggestion by default in a case of timeout. The suggestion unaccepted after timeout may alternatively be implemented as not rejecting after timeout, that is, accepting a suggestion by default in a case of timeout.

According to the method provided in this embodiment, the suggestion information is displayed on the virtual environment interface. A game process of performing a game battle in a virtual scene is not affected, and the suggestion information is displayed, thereby improving information display efficiency.

According to the method provided in this embodiment, the feedback information is displayed, the first account is promptly notified of a processing result of the equipment suggestion for the second virtual object, so that a process of cooperation between the first virtual object and the second virtual object is determined, thereby improving efficiency of human-computer interaction.

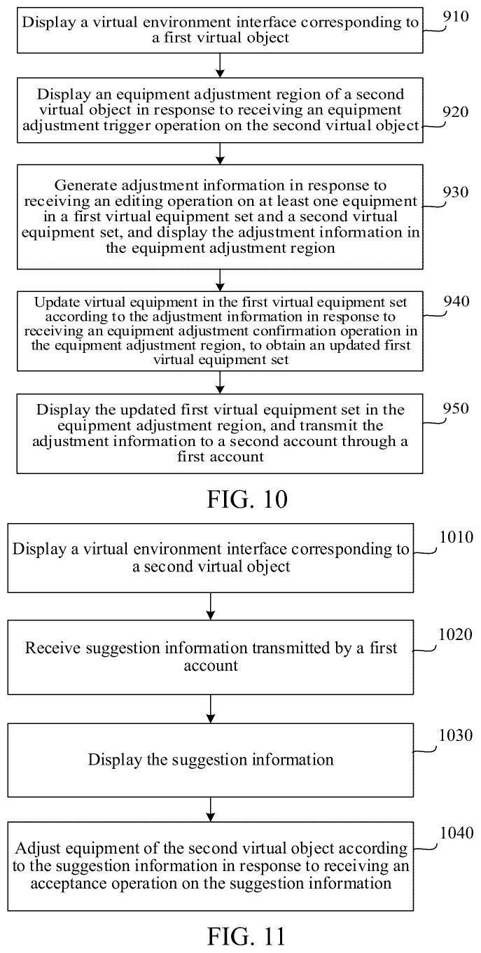

FIG. 10 is a flowchart of an equipment suggestion method for a virtual object according to another exemplary embodiment of the present disclosure. An example in which the method is applied to a first terminal is used for description. The method includes the following operations.

Operation 910: Display a virtual environment interface corresponding to a first virtual object.

For implementation details of operation 910, reference may be made to operation 510. Details are not described herein again.

Operation 920: Display an equipment adjustment region of a second virtual object in response to receiving an equipment adjustment trigger operation on the second virtual object.

For example, in response to the equipment adjustment trigger operation on the virtual environment interface, the first terminal displays the equipment adjustment region of the second virtual object. For example, in response to a third specified operation on the virtual environment interface, the first terminal displays the equipment adjustment region of the second virtual object in the application. The third specified operation is an operation for triggering the equipment adjustment. For example, the third specified operation may be a knuckle double-tap operation on the virtual environment interface; a specified gesture operation on the virtual environment interface; or a long-press operation on the virtual environment interface.

In some embodiments, in response to an equipment viewing operation on the virtual environment picture, the first terminal displays the equipment display region. The equipment display region includes first virtual equipment equipped on the second virtual object. After viewing the first virtual equipment equipped on the second virtual object, the first user wants to adjust equipment of the second virtual object, and needs to perform the equipment adjustment trigger operation on the equipment display region. In response to the equipment adjustment trigger operation on the equipment display region, the first terminal displays the equipment adjustment region of the second virtual object. For example, in response to a fourth specified operation on the equipment adjustment region, the first terminal displays the equipment adjustment region of the second virtual object in the application. The fourth specified operation is an operation for triggering the equipment adjustment. For example, the fourth specified operation may be a knuckle double-tap operation on the equipment display region; a specified gesture operation on the equipment display region; a long-press operation on the equipment display region; or a trigger control including the equipment adjustment corresponding to the second virtual object in the equipment display region. In response to a trigger operation on the trigger control of the equipment adjustment, the first terminal displays the equipment adjustment region of the second virtual object. A second virtual equipment set of optional equipment of the second virtual object is further displayed in the equipment adjustment region.

Operation 930: Generate adjustment information in response to receiving an editing operation on at least one equipment in a first virtual equipment set and a second virtual equipment set, and display the adjustment information in the equipment adjustment region.

In some embodiments, a process of selecting at least one equipment to generate the adjustment information includes, but is not limited to, at least one of the following manners:

(1) A virtual equipment set of the second virtual object is displayed in the equipment suggestion region, where the virtual equipment set includes a first virtual equipment set and a second virtual equipment set; and in response to a selection operation on at least one virtual equipment in the virtual equipment set, the adjustment information is generated according to the suggested at least one virtual equipment, and the adjustment information is displayed in the equipment suggestion region.

(2) In response to a selection operation on first virtual equipment in the first virtual equipment set, first adjustment information is generated according to the first virtual equipment, and the first adjustment information is displayed in the equipment adjustment region.

Alternatively, in response to a selection operation on second virtual equipment in the second virtual equipment set, second adjustment information is generated according to the second virtual equipment, and the second adjustment information is displayed in the equipment adjustment region.

Alternatively, in response to a selection operation on first virtual equipment in the first virtual equipment set, first adjustment information is generated according to the first virtual equipment, and the first adjustment information is displayed in the equipment adjustment region; and in response to a selection operation on second virtual equipment in the second virtual equipment set, second adjustment information is generated according to the second virtual equipment, and the second adjustment information is displayed in the equipment adjustment region.

For generation of the adjustment information, reference may be made to the process of generating the suggestion information, and the adjustment information is also generated by using a template. In this embodiment of the present disclosure, a generation order of the first adjustment information and the second adjustment information is consistent with a selection order of the first virtual equipment and the second virtual equipment. There may be one or more selected first virtual equipment, and there may be one or more selected second virtual equipment.

Operation 940: Update virtual equipment in the first virtual equipment set according to the adjustment information in response to receiving an equipment adjustment confirmation operation in the equipment adjustment region, to obtain an updated first virtual equipment set.

In some embodiments, a process of obtaining the updated first virtual equipment set includes, but is not limited to, at least one of the following manners:

In response to receiving the equipment adjustment confirmation operation in the equipment adjustment region, the first virtual equipment equipped on the second virtual object is unequipped according to the first adjustment information, to obtain the updated first virtual equipment set.

In response to receiving the equipment adjustment confirmation operation in the equipment adjustment region, the second virtual equipment is equipped on the second virtual object according to the second adjustment information, to obtain the updated first virtual equipment set.

Operation 950: Display the updated first virtual equipment set in the equipment adjustment region, and transmit the adjustment information to a second account through a first account.

In some embodiments, a process of displaying the updated first virtual equipment set includes, but is not limited to, at least one of the following manners:

Display of the first virtual equipment in the first virtual equipment set is canceled.

The second virtual equipment is displayed in the first virtual equipment set.

In some embodiments, the first account first transmits an equipment adjustment request to the second account, where the equipment adjustment request is configured for requesting the second account that the first account adjust equipment of the second virtual object. In response to receiving equipment adjustment consent information fed back by the second account, the first account has a permission to perform equipment adjustment on the second virtual object.

Based on the foregoing, according to the equipment suggestion method for a virtual object provided in this embodiment, the first user can modify equipment building for the second virtual object in the team. For a player who knows the equipment building, the equipment building of the second virtual object can be directly modified after permission of the second user is obtained, thereby improving adjustment efficiency of the equipment building of the second virtual object.

FIG. 11 is a flowchart of an equipment adjustment method for a virtual object according to an exemplary embodiment of the present disclosure. An example in which the method is applied to a second terminal is used for description. The method includes the following operations.

Operation 1010: Display a virtual environment interface corresponding to a second virtual object.

The second terminal runs an application, and displays the virtual environment interface of the second virtual object in the application. The virtual environment interface includes a virtual environment picture. The virtual environment picture is a picture obtained by observing a virtual environment from a perspective of the second virtual object. A first virtual object and the second virtual object are in the virtual environment, and the second virtual object and the first virtual object belong to a same team. For example, the virtual environment picture is a picture obtained by observing the virtual environment in a battle process.

For example, when the virtual environment is observed from a first-person perspective of the second virtual object, the virtual environment picture does not include the second virtual object; and when the virtual environment is observed from a third-person perspective of the second virtual object, the virtual environment picture includes the second virtual object.

For example, when the first virtual object is located within an observing range of the second virtual object, the virtual environment picture includes the first virtual object, and the first virtual object is displayed on the virtual environment interface; and when the first virtual object is located outside the observing range of the second virtual object, the virtual environment picture does not include the first virtual object, and the first virtual object is not displayed on the virtual environment interface.

Operation 1020: Receive suggestion information transmitted by a first account.

The first account is an account configured for controlling the first virtual object, a second account is an account configured for controlling the second virtual object, and the suggestion information is an adjustment suggestion for equipment of the second virtual object.

Operation 1030: Display the suggestion information.

The suggestion information is displayed on the virtual environment interface. For example, as shown in FIG. 2, the second terminal displays the suggestion information 108 on the virtual environment interface 201.

Operation 1040: Adjust equipment of the second virtual object according to the suggestion information in response to receiving an acceptance operation on the suggestion information.

For example, as shown in FIG. 2, an acceptance control 203 and a rejection control 204 are further displayed on the virtual environment interface 201. In response to an acceptance operation on the acceptance control 203, the equipment of the second virtual object is adjusted according to the suggestion information, for example, unequipping and selling the “equipment 12”, and purchasing and equipping the “equipment 32”, which is shown in the equipment display region 206 in FIG. 2.

In some embodiments, the adjusting equipment of the second virtual object according to the suggestion information includes at least one of the following operations:

First virtual equipment equipped on the second virtual object is unequipped according to the suggestion information. As shown in FIG. 2, the “equipment 12” of the “character 04” is unequipped according to the suggestion information.

Second virtual equipment is equipped on the second virtual object according to the suggestion information. As shown in FIG. 2, the “equipment 32” is equipped on the “character 04” according to the suggestion information.

In some embodiments, when a virtual resource possessed by the second virtual object is greater than or equal to a virtual resource to be paid for exchanging the second virtual equipment, the second virtual equipment suggested to be equipped in the suggestion information is purchased, and the second virtual equipment is equipped on the second virtual object; or

when a virtual resource possessed by the second virtual object is less than a virtual resource to be paid for exchanging the second virtual equipment, a waiting to purchase task of the second virtual equipment is established; and when the virtual resource possessed by the second virtual object grows to be greater than or equal to the virtual resource to be paid for purchasing the second virtual equipment, the second virtual equipment is purchased, and the second virtual equipment is equipped on the second virtual object.

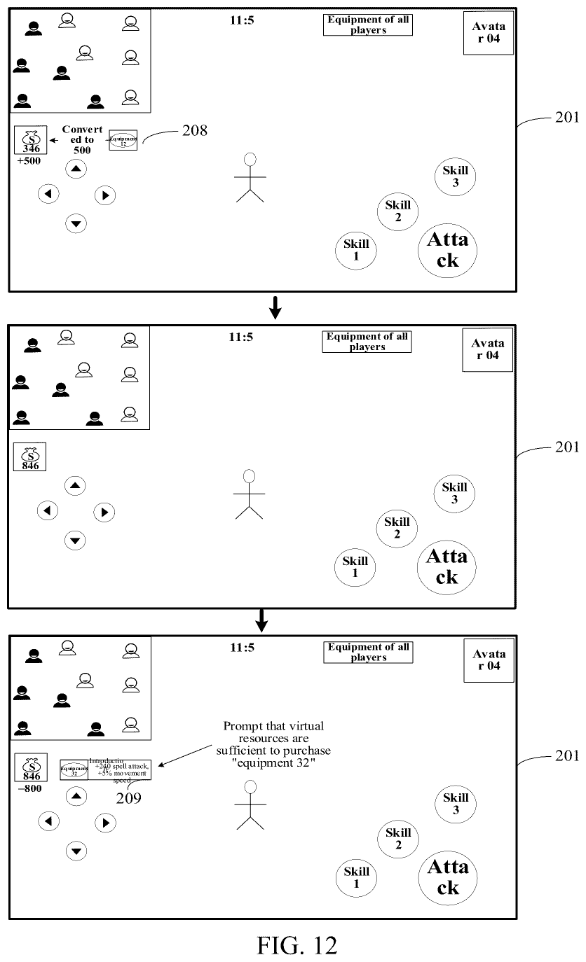

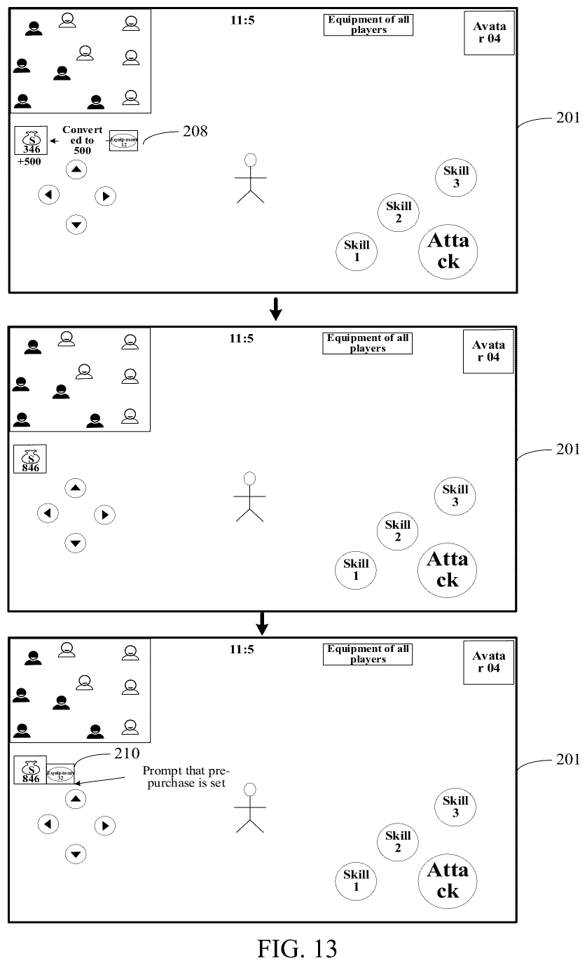

For example, the second terminal obtains the first virtual equipment to be unequipped and the second virtual equipment to be equipped from the suggestion information. First, the first virtual equipment is sold. As shown in FIG. 12, prompt content 208 indicating that “equipment 12” is sold and 500 virtual gold coins are obtained is displayed on a virtual environment interface 201, where the prompt content 208 is in a combined form of graphics and texts. When virtual gold coins in a wallet of the second virtual object are sufficient to purchase the “equipment 32”, required virtual gold coins are deducted from the wallet, the “equipment 32” is purchased, and prompt content 209 is displayed. As shown in FIG. 13, when the virtual gold coins in the wallet of the second virtual object are insufficient to purchase “equipment 32”, an identifier 210 of the “equipment 32” is displayed around the wallet to prompt that the “equipment 32” is set as pre-purchase. When the virtual gold coins in the wallets are sufficient, the “equipment 32” is automatically purchased immediately.

Based on the foregoing, according to the equipment adjustment method for a virtual object provided in this embodiment, a second user can adjust equipment building of a second virtual object in a manner of one-tap/click acceptance of a suggestion, without the need for the second user to find equipment that needs to be adjusted, which greatly improves adjustment efficiency of the equipment building of the second virtual object of the second user, and improves human-computer interaction efficiency.

In some embodiments, in response to receiving an acceptance operation on the suggestion information, the second terminal transmits feedback information indicating that the suggestion is accepted to the first account through the second account.

Alternatively, in response to receiving a rejection operation on the suggestion information, the second terminal transmits feedback information indicating that the suggestion is rejected to the first account through the second account.

Alternatively, in response to a display duration of the suggestion information exceeding a duration threshold, the second terminal transmits feedback information indicating that the suggestion is not accepted after timeout to the first account through the second account, to indicate that the second user neither accepts or rejects the suggestion information in a case of timeout. The display duration refers to a display duration of the suggestion information on the virtual environment interface. For example, as shown in FIG. 2, a countdown is displayed on the virtual environment interface 201. When the countdown is zero, the display duration of the suggestion information exceeds the duration threshold, and the second terminal further transmits feedback information indicating that the suggestion is not accepted after timeout to the first account through the second account.

In this method, a processing result of the second user on the suggestion information is further fed back to the first user, so that the second user can timely learn of an equipment state of the second virtual object without viewing the equipment of the second virtual object. For example, for whether the second virtual object still uses the original equipment building manner or adjusts the equipment building manner according to the suggestion information, even if there is no conversation between the first user and the second user, communication about the equipment building is completed, which saves communication operations about whether to accept the suggestion or not, improving communication efficiency between users.

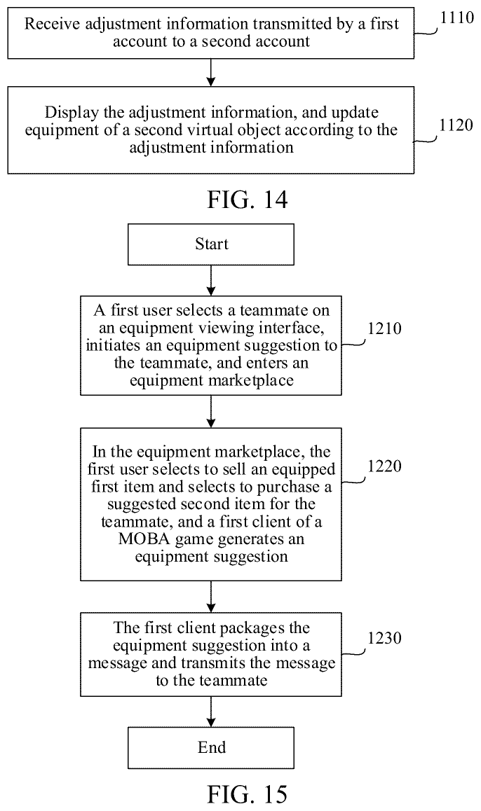

FIG. 14 is a flowchart of an equipment adjustment method for a virtual object according to another exemplary embodiment of the present disclosure. An example in which the method is applied to a second terminal is used for description. The method includes the following operations.

Operation 1110: Receive adjustment information transmitted by a first account to a second account.

The second terminal receives the adjustment information transmitted by a first terminal to the second account through the first account, where the adjustment information is configured for instructing the second terminal to adjust equipment of the second virtual object.

In some embodiments, the adjustment information includes at least one of the following: unequipping first virtual equipment of the second virtual object; and equipping second virtual equipment on the second virtual object.

In some embodiments, the adjustment information includes a plurality of virtual equipment re-adjusted for the second virtual object.

Operation 1120: Display the adjustment information, and update the equipment of the second virtual object according to the adjustment information.

The second terminal updates a first virtual equipment set of the second virtual object according to the adjustment information. For example, when the adjustment information includes the plurality of virtual equipment re-adjusted for the second virtual object, the second terminal clears the first virtual equipment set, and directly updates the plurality of virtual equipment in the adjustment information to the first virtual equipment set, to obtain an updated first virtual equipment set.

Subsequently, the second user views the equipment of the second virtual object, and the updated first virtual equipment set is displayed in the equipment display region. As shown in the equipment display region 206 in FIG. 2, the “equipment 12” is no longer displayed, and the “equipment 32” newly equipped on the second virtual object is displayed.

Based on the foregoing, according to the equipment adjustment method for a virtual object provided in this embodiment, with permission of the second user, the first user may directly adjust equipment building of the second virtual object, which greatly improves adjustment efficiency of the equipment building of the second virtual object, and improves human-computer interaction efficiency.

Besides, after receiving adjustment information, the second terminal displays the adjustment information on the virtual environment interface, so that the second user can learn an equipment state of the second virtual object after the adjustment without entering an equipment display region.

FIG. 15 is a flowchart of an equipment suggestion method for a virtual object according to another exemplary embodiment of the present disclosure. Taking an equipment suggestion in a MOBA game as an example, a process of a first user making an equipment building suggestion for a virtual object to a teammate (that is, a second user) includes the following operations.

Operation 1210: The first user selects a teammate on an equipment viewing interface, initiates an equipment suggestion to the teammate, and enters an equipment marketplace.

Operation 1220: In the equipment marketplace, the first user selects to sell an equipped first item and selects to purchase a suggested second item for the teammate, and a first client of the MOBA game generates an equipment suggestion.

Operation 1230: The first client packages the equipment suggestion into a message and transmits the message to the teammate.

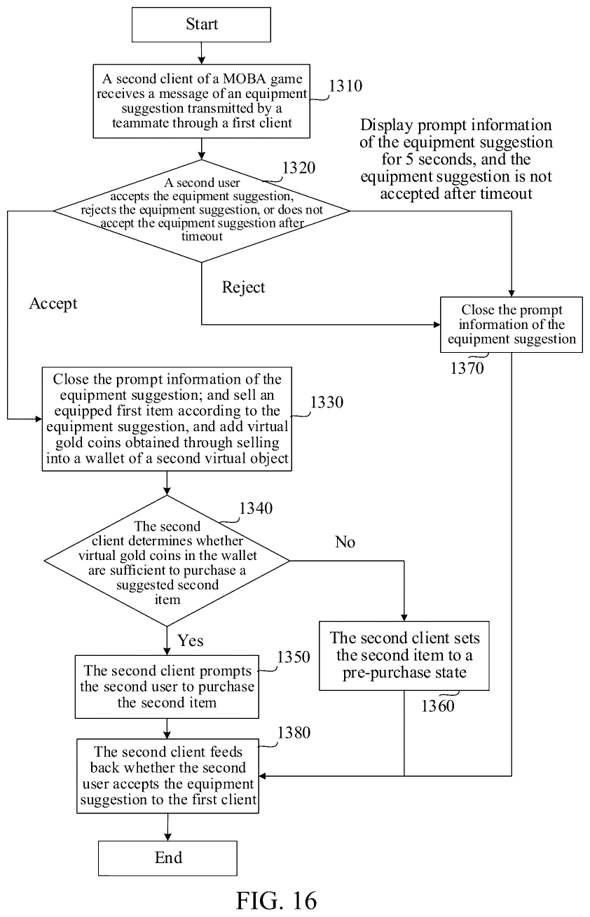

FIG. 16 is a flowchart of an equipment adjustment method for a virtual object according to another exemplary embodiment of the present disclosure. Taking an equipment suggestion in a MOBA game as an example, a process of a second user adjusting equipment for a virtual object according to a suggestion of a teammate (that is, a first user) includes the following operations.

Operation 1310: A second client of the MOBA game receives a message of an equipment suggestion transmitted by the teammate through a first client.

Operation 1320: A second user accepts the equipment suggestion, rejects the equipment suggestion, or does not accept the equipment suggestion after timeout.

If the second user performs an operation of accepting the equipment suggestion, the second client performs operation 1330; if the second user performs an operation of rejecting the equipment suggestion, the second client performs operation 1370; and if no operation is performed, after counting down 5 seconds, the second client processes the equipment suggestion as suggestion unaccepted after timeout and performs operation 1370.

Operation 1330: The second client closes prompt information of the equipment suggestion, and sells an equipped first item according to the equipment suggestion, and adds virtual gold coins obtained through selling into a wallet of a second virtual object.

Operation 1340: The second client determines whether virtual gold coins in the wallet are sufficient to purchase a suggested second item.

If the virtual gold coins in the wallet are sufficient to purchase the second item, operation 1350 is performed; and if the virtual gold coins in the wallet are insufficient to purchase the second item, operation 1360 is performed.

Operation 1350: The second client prompts the second user to purchase the second item. Operation 1380 is subsequently performed.

Operation 1360: The second client sets the second item to a pre-purchase state.

When the second item is in the pre-purchase state, when the wallet has income, the second client detects whether the virtual gold coins in the wallet are sufficient to purchase the second item, and if the virtual gold coins in the wallet are sufficient to purchase the second item, the prompt information is popped up to prompt the second user to purchase the second item. Operation 1380 is subsequently performed.

Operation 1370: The second client closes the prompt information of the equipment suggestion. Operation 1380 is subsequently performed.

Operation 1380: The second client feeds back whether the second user accepts the equipment suggestion to the first client.

Based on the foregoing, according to the equipment suggestion method for a virtual object provided in this embodiment, the first user determines suggestion information for selling the first item and purchasing the second item on the first client, and then transmits the suggestion information to the second client, and the suggestion information is displayed on the second client. The second user may choose to accept the suggestion information. After one-tap/click acceptance, the second client performs operations of selling the first item and purchasing the second item, so that the first user who is proficient in equipment building can better provide a suggestion for the second user. Through the operation of one-tap/click acceptance, the second user efficiently completes an equipment adjustment operation of the second virtual object on the second client, improving efficiency of human-computer interaction.

The embodiments of the present disclosure are not limited to the above-mentioned manual operations to select the suggested equipment. Alternatively, the suggestion information may be extracted from a suggestion speech entered by the first user through a speech input manner, and then the suggestion information is transmitted to the second account. In this way, no manual operation is required to edit the suggestion information. In the embodiments of the present disclosure, it is not limited to pushing a suggestion of unequipping or equipping virtual equipment. For example, suggestion information for throwing out a virtual item or picking up a virtual item may also be pushed.

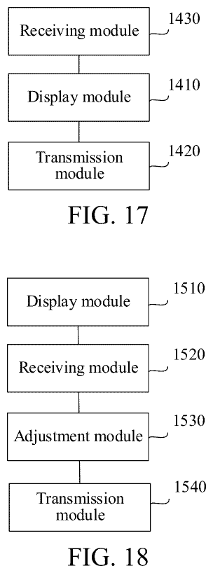

FIG. 17 is a block diagram of an equipment suggestion apparatus for a virtual object according to an exemplary embodiment of the present disclosure. The apparatus may become part or all of a first terminal through software, hardware, or a combination of both, and the apparatus includes:
a display module 1410, configured to display a virtual environment interface corresponding to a first virtual object, where a virtual environment includes a second virtual object;
the display module 1410 being configured to display an equipment suggestion region of the second virtual object in response to receiving an equipment suggestion trigger operation on the second virtual object;
the display module 1410 being configured to display suggestion information in the equipment suggestion region in response to receiving an equipment suggestion editing operation in the equipment suggestion region, where the suggestion information is configured for representing an equipment configuration recommended by a first account to a second account, the first account is a master account of the first virtual object, and the second account is a master account of the second virtual object; and
a transmission module 1420, configured to transmit the suggestion information to the second account through the first account in response to receiving an equipment suggestion confirmation operation in the equipment suggestion region.

In some embodiments, the equipment suggestion region includes a first virtual equipment set equipped on the second virtual object and a candidate second virtual equipment set; and
a display module 1410, configured to:
generate the suggestion information in response to receiving an editing operation on at least one equipment in the first virtual equipment set and the second virtual equipment set, and display the suggestion information in the equipment suggestion region.

In some embodiments, the display module 1410 is further configured to:
generate, in response to receiving a selection operation on first virtual equipment in the first virtual equipment set, first suggestion information according to the first virtual equipment; and display the first suggestion information in the equipment suggestion region, where the first suggestion information is configured for suggesting unequipping the first virtual equipment equipped on the second virtual object; or
generate, in response to receiving a selection operation on second virtual equipment in the second virtual equipment set, second suggestion information according to the second virtual equipment; and display the second suggestion information in the equipment suggestion region, where the second suggestion information is configured for suggesting equipping the second virtual equipment on the second virtual object.

In some embodiments, the display module 1410 is further configured to:
display reference information of an equipment suggestion for the second virtual object in the equipment suggestion region, where the reference information is determined according to equipment information of the second virtual object and equipment information of another virtual object; and the another virtual object includes at least one of the following: a virtual object in a same team as the second virtual object, or a virtual object in an opponent team of the second virtual object; and
use edited reference information as the suggestion information in response to receiving an editing operation on the reference information in the equipment suggestion region.

In some embodiments, the display module 1410 is further configured to:
display an equipment display region in response to receiving an equipment viewing operation, where the equipment display region includes the first virtual equipment equipped on the second virtual object and a trigger control of an equipment suggestion corresponding to the second virtual object; and
display the equipment suggestion region of the second virtual object in response to receiving a trigger operation on the trigger control of the equipment suggestion.

In some embodiments, the display module 1410 is configured to display the suggestion information on a virtual environment picture in response to receiving the equipment suggestion confirmation operation in the equipment suggestion region.

In some embodiments, the apparatus includes: a receiving module 1430, where
the receiving module 1430 is configured to receive feedback information transmitted by the second account to the first account; and
the display module 1410, configured to display the feedback information on the virtual environment picture, where the feedback information includes any one of suggestion accepted, suggestion rejected, or suggestion unaccepted after timeout.

In some embodiments, the display module 1410 is further configured to:
display an equipment adjustment region of the second virtual object in response to receiving an equipment adjustment trigger operation on the second virtual object, where a first virtual equipment set equipped on the second virtual object and a candidate second virtual equipment set are displayed in the equipment adjustment region;
generate adjustment information in response to receiving an editing operation on at least one equipment in the first virtual equipment set and the second virtual equipment set, and display the adjustment information in the equipment adjustment region;
update virtual equipment in the first virtual equipment set according to the adjustment information in response to receiving an equipment adjustment confirmation operation in the equipment adjustment region, to obtain an updated first virtual equipment set; and displaying the updated first virtual equipment set in the equipment adjustment region; and
transmit the adjustment information to the second account through the first account.

In some embodiments, the display module 1410 is further configured to:
generate, in response to the selection operation on the first virtual equipment in the first virtual equipment set, first adjustment information according to the first virtual equipment, and display the first adjustment information on the equipment adjustment region; and
in response to receiving the equipment adjustment confirmation operation in the equipment adjustment region, unequip, according to the first adjustment information, the first virtual equipment equipped on the second virtual object, to obtain the updated first virtual equipment set; and canceling display of the first virtual equipment in the first virtual equipment set.

In some embodiments, the display module 1410 is further configured to:
generate, in response to the selection operation on the second virtual equipment in the second virtual equipment set, second adjustment information according to the second virtual equipment, and display the second adjustment information in the equipment adjustment region; and
equip the second virtual equipment on the second virtual object according to the second adjustment information in response to receiving the equipment adjustment confirmation operation in the equipment adjustment region, to obtain the updated first virtual equipment set; and display the second virtual equipment in the first virtual equipment set.

FIG. 18 is a block diagram of an equipment adjustment apparatus for a virtual object according to an exemplary embodiment of the present disclosure. The apparatus may become part or all of a second terminal through software, hardware, or a combination of both, and the apparatus includes:
a display module 1510, configured to display a virtual environment interface corresponding to a second virtual object, where a virtual environment includes a first virtual object;
a receiving module 1520 being configured to receive suggestion information transmitted by a first account, where the first account is a master account of the first virtual object, a second account is a master account of the second virtual object, and the suggestion information is an adjustment suggestion for an equipment of the second virtual object;
the display module 1510 being configured to display the suggestion information; and
an adjustment module 1530, configured to adjust the equipment of the second virtual object according to the suggestion information in response to receiving an acceptance operation on the suggestion information.

In some embodiments, the adjustment module 1530 is further configured to:
unequip, according to the suggestion information, first virtual equipment equipped on the second virtual object; and/or
equip second virtual equipment on the second virtual object according to the suggestion information.

In some embodiments, the adjustment module 1530 is further configured to:
when a virtual resource possessed by the second virtual object is greater than or equal to a virtual resource to be paid for exchanging the second virtual equipment, purchase the second virtual equipment suggested to be equipped in the suggestion information, and equip the second virtual equipment on the second virtual object; or
when a virtual resource possessed by the second virtual object is less than a virtual resource to be paid for exchanging the second virtual equipment, establish a waiting to purchase task of the second virtual equipment; and when the virtual resource possessed by the second virtual object grows to be greater than or equal to the virtual resource to be paid for exchanging the second virtual equipment, purchase the second virtual equipment, and equip the second virtual equipment on the second virtual object.

In some embodiments, the apparatus further includes: a transmission module 1540; and
the transmission module 1540 being configured to transmit, in response to receiving the acceptance operation on the suggestion information, feedback information indicating that the suggestion is accepted to the first account through the second account.

In some embodiments,
the receiving module 1520 is configured to receive adjustment information transmitted by the first account to the second account;
the display module 1510 is configured to display the adjustment information; and
the adjustment module 1530 is configured to update equipment of the second virtual object according to the adjustment information.

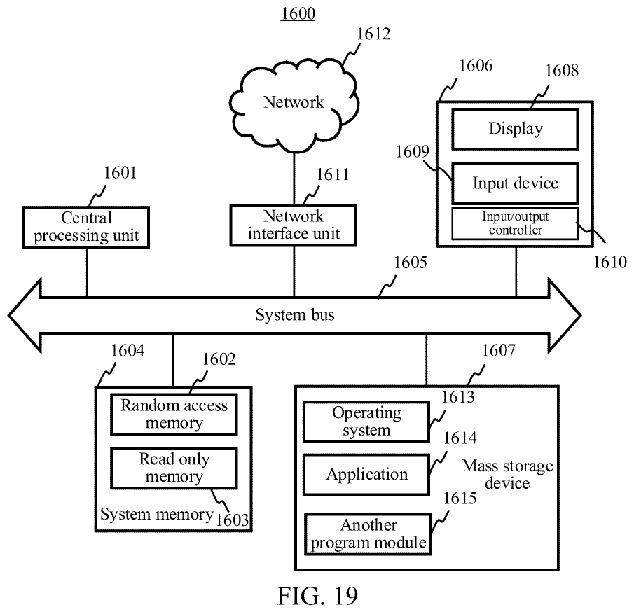

FIG. 19 is a schematic structural diagram of a computer device according to an exemplary embodiment of the present disclosure. The computer device may be a terminal that performs the equipment suggestion method for a virtual object and/or the equipment adjustment method for a virtual object provided in the present disclosure. Specifically as follows:

A computer device 1600 includes a central processing unit (CPU) 1601, a system memory 1604 including a random access memory (RAM) 1602 and a read-only memory (ROM) 1603, and a system bus 1605 connecting the system memory 1604 and the central processing unit 1601. The computer device 1600 further includes a basic input/output system (I/O system) 1606 assisting in transmitting information between components in a computer, and a mass storage device 1607 configured to store an operating system 1613, an application 1614, and another program module 1615. The basic input/output system 1606 includes a display 1608 configured to display information and an input device 1609 such as a mouse or a keyboard for a user to input information. The display 1608 and the input device 1609 are both connected to the central processing unit 1601 by using an input/output controller 1610 that is connected to the system bus 1605. The basic input/output system 1606 may further include the input and output controller 1610 for receiving and processing inputs from a plurality of other devices such as a keyboard, a mouse, or an electronic stylus. Similarly, the input/output controller 1610 further provides an output to a display screen, a printer, or another type of output device. The mass storage device 1607 is connected to the central processing unit 1601 by using a mass storage controller (not shown) that is connected to the system bus 1605. The mass storage device 1607 and a computer-readable medium associated with the large-capacity storage device provide non-volatile storage to the computer device 1600. That is, the mass storage device 1607 may include a computer-readable medium (not shown) such as a hard disk or a compact disc read only memory (CD-ROM) drive.

The computer readable medium may include a computer storage medium and a communications medium. The system memory 1604 and the mass storage device 1607 may be collectively referred to as a memory. According to the embodiments of the present disclosure, the computer device 1600 may further be connected, through a network such as the Internet, to a remote computer on the network and run. That is, the computer device 1600 may be connected to a network 1612 by using a network interface unit 1611 connected to the system bus 1605, or may be connected to another type of network or a remote computer system (not shown) by using a network interface unit 1611. The memory further includes one or more programs, which are stored in the memory and are configured to be executed by the CPU, to implement the equipment suggestion method for a virtual object and/or the equipment adjustment method for a virtual object.

An embodiment of the present disclosure further provides a computer-readable storage medium, having at least one instruction stored therein, where the at least one instruction is loaded and executed by a processor to implement the equipment suggestion method for a virtual object and/or the equipment adjustment method for a virtual object described in the foregoing embodiments.

As such, according to various embodiments of the present disclosure, a first user controls the first virtual object through the first account. For the second virtual object that is at the same team as the first virtual object, the first user may trigger to enter the equipment suggestion region of the second virtual object, edit the suggestion information for equipment of the second virtual object in the equipment suggestion region, and then transmit, through the first account, the suggestion information to the second account controlling the second virtual object, to provide a suggestion for equipment building of the second virtual object. Therefore, a second user may adjust the equipment building of the second virtual object according to the suggestion information, to achieve effective communication about equipment building between virtual objects in the same team.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. An equipment suggestion method for a virtual object, performed by a terminal, the method comprising:
displaying a virtual environment interface corresponding to a first virtual object, a virtual environment comprising a second virtual object;
displaying an equipment suggestion region of the second virtual object in response to receiving an equipment suggestion trigger operation on the second virtual object;
displaying suggestion information in the equipment suggestion region in response to receiving an equipment suggestion editing operation in the equipment suggestion region, the suggestion information indicating an equipment configuration recommended by a first account to a second account, the first account being a master account of the first virtual object, and the second account being a master account of the second virtual object; and
transmitting the suggestion information to the second account through the first account in response to receiving an equipment suggestion confirmation operation in the equipment suggestion region.

2. The method according to claim 1, wherein the equipment suggestion region comprises a first virtual equipment set equipped on the second virtual object and a candidate second virtual equipment set; and
displaying the suggestion information in the equipment suggestion region in response to receiving the equipment suggestion editing operation in the equipment suggestion region comprises:
generating the suggestion information in response to receiving an editing operation on at least one equipment in the first virtual equipment set and the second virtual equipment set, and displaying the suggestion information in the equipment suggestion region.

3. The method according to claim 2, wherein generating the suggestion information in response to receiving the editing operation on the at least one equipment in the first virtual equipment set and the second virtual equipment set, and displaying the suggestion information in the equipment suggestion region comprises at least one of following operations:
generating, in response to receiving a selection operation on first virtual equipment in the first virtual equipment set, first suggestion information according to the first virtual equipment; and displaying the first suggestion information in the equipment suggestion region, wherein the first suggestion information is configured for suggesting unequipping the first virtual equipment equipped on the second virtual object; or
generating, in response to receiving a selection operation on second virtual equipment in the second virtual equipment set, second suggestion information according to the second virtual equipment; and displaying the second suggestion information in the equipment suggestion region, wherein the second suggestion information is configured for suggesting equipping the second virtual equipment on the second virtual object.

4. The method according to claim 1, further comprising:
displaying reference information of an equipment suggestion for the second virtual object in the equipment suggestion region, wherein the reference information is determined according to equipment information of the second virtual object and equipment information of another virtual object; and the another virtual object comprises at least one of following: a virtual object in a same team as the second virtual object, or a virtual object in an opponent team of the second virtual object; and
displaying the suggestion information in the equipment suggestion region in response to receiving the equipment suggestion editing operation in the equipment suggestion region comprises:
using edited reference information as the suggestion information in response to receiving an editing operation on the reference information in the equipment suggestion region.

5. The method according to claim 1, further comprising:
displaying an equipment display region in response to receiving an equipment viewing operation, wherein the equipment display region comprises the first virtual equipment equipped on the second virtual object and a trigger control of an equipment suggestion corresponding to the second virtual object; and
displaying the equipment suggestion region of the second virtual object in response to receiving the equipment suggestion trigger operation on the second virtual object comprises:
displaying the equipment suggestion region of the second virtual object in response to receiving a trigger operation on the trigger control of the equipment suggestion.

6. The method according to claim 1, further comprising:
displaying the suggestion information on a virtual environment picture in response to receiving the equipment suggestion confirmation operation in the equipment suggestion region.

7. The method according to claim 1, further comprising:
receiving feedback information transmitted by the second account to the first account; and
displaying the feedback information on the virtual environment picture, wherein the feedback information comprises any one of suggestion accepted, suggestion rejected, or suggestion unaccepted after timeout.

8. The method according to claim 1, further comprising:
displaying an equipment adjustment region of the second virtual object in response to receiving an equipment adjustment trigger operation on the second virtual object, wherein a first virtual equipment set equipped on the second virtual object and a candidate second virtual equipment set are displayed in the equipment adjustment region;
generating adjustment information in response to receiving an editing operation on at least one equipment in the first virtual equipment set and the second virtual equipment set, and displaying the adjustment information in the equipment adjustment region;
updating virtual equipment in the first virtual equipment set according to the adjustment information in response to receiving an equipment adjustment confirmation operation in the equipment adjustment region, to obtain an updated first virtual equipment set; and displaying the updated first virtual equipment set in the equipment adjustment region; and
transmitting the adjustment information to the second account through the first account.

9. The method according to claim 8, wherein generating the adjustment information in response to receiving the editing operation on the at least one equipment in the first virtual equipment set and the second virtual equipment set, and displaying the adjustment information in the equipment adjustment region comprises:
generating, in response to a selection operation on first virtual equipment in the first virtual equipment set, first adjustment information according to the first virtual equipment, and displaying the first adjustment information in the equipment adjustment region; and
updating the virtual equipment in the first virtual equipment set according to the adjustment information in response to receiving an equipment adjustment confirmation operation in the equipment adjustment region, to obtain an updated first virtual equipment set; and displaying the updated first virtual equipment set in the equipment adjustment region comprises:
in response to receiving the equipment adjustment confirmation operation in the equipment adjustment region, unequipping, according to the first adjustment information, the first virtual equipment equipped on the second virtual object, to obtain the updated first virtual equipment set; and canceling display of the first virtual equipment in the first virtual equipment set.

10. The method according to claim 8, wherein generating the adjustment information in response to receiving the editing operation on the at least one equipment in the first virtual equipment set and the second virtual equipment set, and displaying the adjustment information in the equipment adjustment region comprises:
generating, in response to a selection operation on second virtual equipment in the second virtual equipment set, second adjustment information according to the second virtual equipment, and displaying the second adjustment information in the equipment adjustment region; and
updating the virtual equipment in the first virtual equipment set according to the adjustment information in response to receiving an equipment adjustment confirmation operation in the equipment adjustment region, to obtain an updated first virtual equipment set; and displaying the updated first virtual equipment set in the equipment adjustment region comprises:
equipping the second virtual equipment on the second virtual object according to the second adjustment information in response to receiving the equipment adjustment confirmation operation in the equipment adjustment region, to obtain the updated first virtual equipment set; and displaying the second virtual equipment in the first virtual equipment set.

11. A terminal, comprising one or more processors and a memory coupled to the one or more processors and containing program instructions that, when being executed, cause the one or more processors to perform:
displaying a virtual environment interface corresponding to a first virtual object, a virtual environment comprising a second virtual object;
displaying an equipment suggestion region of the second virtual object in response to receiving an equipment suggestion trigger operation on the second virtual object;
displaying suggestion information in the equipment suggestion region in response to receiving an equipment suggestion editing operation in the equipment suggestion region, the suggestion information indicating an equipment configuration recommended by a first account to a second account, the first account being a master account of the first virtual object, and the second account being a master account of the second virtual object; and
transmitting the suggestion information to the second account through the first account in response to receiving an equipment suggestion confirmation operation in the equipment suggestion region.

12. The terminal according to claim 11, wherein the equipment suggestion region comprises a first virtual equipment set equipped on the second virtual object and a candidate second virtual equipment set; and the one or more processors are further configured to perform:
generating the suggestion information in response to receiving an editing operation on at least one equipment in the first virtual equipment set and the second virtual equipment set, and displaying the suggestion information in the equipment suggestion region.

13. The terminal according to claim 12, wherein the one or more processors are further configured to perform at least one of following operations:
generating, in response to receiving a selection operation on first virtual equipment in the first virtual equipment set, first suggestion information according to the first virtual equipment; and displaying the first suggestion information in the equipment suggestion region, wherein the first suggestion information is configured for suggesting unequipping the first virtual equipment equipped on the second virtual object; or
generating, in response to receiving a selection operation on second virtual equipment in the second virtual equipment set, second suggestion information according to the second virtual equipment; and displaying the second suggestion information in the equipment suggestion region, wherein the second suggestion information is configured for suggesting equipping the second virtual equipment on the second virtual object.

14. The terminal according to claim 11, wherein the one or more processors are further configured to perform:
displaying reference information of an equipment suggestion for the second virtual object in the equipment suggestion region, wherein the reference information is determined according to equipment information of the second virtual object and equipment information of another virtual object; and the another virtual object comprises at least one of following: a virtual object in a same team as the second virtual object, or a virtual object in an opponent team of the second virtual object; and
using edited reference information as the suggestion information in response to receiving an editing operation on the reference information in the equipment suggestion region.

15. The terminal according to claim 11, wherein the one or more processors are further configured to perform:
displaying an equipment display region in response to receiving an equipment viewing operation, wherein the equipment display region comprises the first virtual equipment equipped on the second virtual object and a trigger control of an equipment suggestion corresponding to the second virtual object; and
displaying the equipment suggestion region of the second virtual object in response to receiving a trigger operation on the trigger control of the equipment suggestion.

16. The terminal according to claim 11, wherein the one or more processors are further configured to perform:
displaying the suggestion information on a virtual environment picture in response to receiving the equipment suggestion confirmation operation in the equipment suggestion region.

17. The terminal according to claim 11, wherein the one or more processors are further configured to perform:
receiving feedback information transmitted by the second account to the first account; and
displaying the feedback information on the virtual environment picture, wherein the feedback information comprises any one of suggestion accepted, suggestion rejected, or suggestion unaccepted after timeout.

18. The terminal according to claim 11, wherein the one or more processors are further configured to perform:
displaying an equipment adjustment region of the second virtual object in response to receiving an equipment adjustment trigger operation on the second virtual object, wherein a first virtual equipment set equipped on the second virtual object and a candidate second virtual equipment set are displayed in the equipment adjustment region;
generating adjustment information in response to receiving an editing operation on at least one equipment in the first virtual equipment set and the second virtual equipment set, and displaying the adjustment information in the equipment adjustment region;
updating virtual equipment in the first virtual equipment set according to the adjustment information in response to receiving an equipment adjustment confirmation operation in the equipment adjustment region, to obtain an updated first virtual equipment set; and displaying the updated first virtual equipment set in the equipment adjustment region; and
transmitting the adjustment information to the second account through the first account.

19. The terminal according to claim 18, wherein the one or more processors are further configured to perform:
generating, in response to a selection operation on first virtual equipment in the first virtual equipment set, first adjustment information according to the first virtual equipment, and displaying the first adjustment information in the equipment adjustment region; and
in response to receiving the equipment adjustment confirmation operation in the equipment adjustment region, unequipping, according to the first adjustment information, the first virtual equipment equipped on the second virtual object, to obtain the updated first virtual equipment set; and
canceling display of the first virtual equipment in the first virtual equipment set.

20. A non-transitory computer-readable storage medium containing program instructions that, when being executed, cause at least one processor to perform:
displaying a virtual environment interface corresponding to a first virtual object, a virtual environment comprising a second virtual object;
displaying an equipment suggestion region of the second virtual object in response to receiving an equipment suggestion trigger operation on the second virtual object;
displaying suggestion information in the equipment suggestion region in response to receiving an equipment suggestion editing operation in the equipment suggestion region, the suggestion information indicating an equipment configuration recommended by a first account to a second account, the first account being a master account of the first virtual object, and the second account being a master account of the second virtual object; and
transmitting the suggestion information to the second account through the first account in response to receiving an equipment suggestion confirmation operation in the equipment suggestion region.
